(19) United States
(12) Patent Application Publication
(10) Pub. No.: US 2002/0036990 A1
(43) Pub. Date: Mar. 28, 2002

(54) Still picture capture, editing and distribution system utilizing a publicly accessible wide area network

(76) Inventors: Ben Chodor, Westfield, NJ (US); Richard Harte, West Windsor, NJ (US); Les Borowski, Staten Island, NY (US)

Correspondence Address: Proskauer Rose LLP, 1585 Broadway, New York, NY, 10036, US

(21) Appl. No.: 09/728,449

(22) Filed: Dec. 1, 2000

Related U.S. Application Data
(60) Provisional application No. 60/231,666, filed on Sep. 11, 2000.

(51) Int. Cl. H04L 12/16; H04L 12/28

(52) U.S. Cl. 370/262; 370/400; 709/204

(57) ABSTRACT

A system and method facilitate capture and distribution of digital still pictures. A first node with a camera enables a patron user to capture one or more still pictures and transfers captured still pictures to a second node via a publicly accessible WAN. The second node transfers via the publicly accessible WAN copies of captured still pictures to a third node and also receives via the publicly accessible WAN an instruction from the third node designating one or more versions of still pictures derived from the captured still pictures for access by non-patron users. The second node enables transfer via the publicly accessible WAN only the still pictures derived from the captured still pictures, but not other still pictures contained at the second node, to each permitted node, other than a node operated by the patron user.

### RELATED APPLICATIONS

This application is related to the following applications, which are commonly assigned to the same assignee as this application:

U.S. Provisional Application for Patent Ser. No. 60/187,532, entitled “Automated Netcast Service,” filed Mar. 7, 2000, for Richard Harte and Ben Choder;

U.S. Provisional Application for Patent Ser. No. 60/231,666, entitled “Still Picture Capture, Editing And Distribution System Utilizing A Publicly Accessible Wide Area,” filed, for Ben Chodor, Richard Harte and Les Borowski; and

U.S. patent application Ser. No. 09/637,507, entitled “Automated Netcast System For Providing User Broadcast Programming, Such As For An Electronic Commerce Internet Website,” filed Aug. 11, 2000 for Richard Harte and Ben Chodor.

The contents of these applications are incorporated herein by reference.

### COPYRIGHT AND TRADEMARK NOTICE

A portion of the disclosure of this patent document contains material which is subject to copyright and trademark/service mark protection. The trademark/service mark/copyright owner has no objection to the facsimile reproduction by anyone of the patent document or patent disclosure as it appears in the United States Patent and Trademark Office file or records, but otherwise reserves all copyright, trademark and service mark rights whatsoever.

### FIELD OF THE INVENTION

The present invention pertains to capture, editing and distribution of still image pictures, and live broadcast of audio-video signals via a publicly accessible wide area network, such as the Internet, in, for example, an Internet e-commerce website application.

### BACKGROUND OF THE INVENTION

The Internet is an example of a publicly accessible wide area network. While originally designed for communication of “best-effort” or “bursty” transactional or computer data, the Internet can also be used for delivering audio-video program (hereinafter “program”) data, such as audio signals, video signals or both. Unlike ordinary computer data, program data is of a “streamed” nature and must be accessed during playback and presentation (video display on a monitor, audio sound generation on a loudspeaker, etc.) at a prescribed bit rate to prevent discontinuities from being introduced into the presentation. (That is, program data must be available for access during playback and presentation in sufficient, but not too great a quantity, in a paradigm similar to a “just-in-time” inventory system.) Delivery of program data presents many challenges for the Internet, which, as mentioned earlier, was originally designed to deliver transactional data in bursts whenever an opportunity to deliver such data exists (and not according to a “just-in-time” delivery schedule as needed for program data). Nevertheless, several applications and systems are available for delivering programs via the Internet.

Many program communications are first transferred from a source to a destination in a file over the Internet. Then, after delivery of the file is complete, the user may “playback” the program contained in the file. The advantage to this paradigm is that the program information need not be delivered to the playback destination at any particular bit rate. Rather the data of the file can be delivered in bursts until it arrives completely. Once the file is present in its entirety, at some unspecified time after delivery of the file is requested, the user can playback the program in the file. The timely delivery of the program data during playback and presentation can usually be assured so that no discontinuity is delivered into the presentation of the streamed data. This communication technique is often used at web servers for enabling presentation of prerecorded “video clips” or “sound clips” at computer terminals of users. A drawback of this technique is that there is an unpredictable, varying latency between the delivery of the program and the playback of the program on the user's terminal.

Another form of communication pertains to live broadcast distribution of programs. One form of live communication of audio signals via the Internet includes socalled Internet telephone services. Another form of live communication is a so-called “netcast”. A netcast is a live, one-way broadcast of a program signal, from one location to a multitude of other locations. In the past, netcasts have been performed as follows. A camera (with an integrated or separate microphone) and program encoder are set up at the location at which the program signal is to be captured. The program encoder is connected to the Internet for delivery of the program signal. Users of computer terminals connected to the Internet access a predesignated website to receive the broadcasted program. At the start of the netcast, a technician physically present at the location at which the program signal is to be captured manually controls the camera and program encoder to turn them on to start the delivery of the program signal. The encoded program signal is then delivered to all users who have accessed the predesignated site without restriction. The computer terminals operated by the users receive the encoded program signal, decode the encoded program signal and present the decoded program signal (i.e., display images on a video monitor and produce sounds on loudspeakers). When the netcast is to be stopped, the technician who is physically located at the location at which the program signals are captured manually controls the camera and program encoder so that they cease producing an encoded program signal.

This manner of delivery of a netcast is adequate when only a single or a small number of netcasts are to be broadcasted by a single netcast service simultaneously or within a short period of time. However, this netcast system is not amenable for a single netcast service provider who intends to deliver many netcasts simultaneously or within a short period of time. In addition, this netcast delivery system is not capable of restricting the audience which is to receive each netcast.

It is an object of the present invention to overcome the disadvantages of the prior art. It is another object to provide a consumer-use (i.e., consumer schedule-able) netcast service which is easy to schedule and to use. It is a further object to provide one or more “private netcasts” i.e., netcasts which, while delivered via a publicly accessible wide area network, like the Internet, are only distributed to predetermined guest users.

A number of e-commerce websites have also been introduced into the Internet. For example, a company which sells products (e.g., books, CDs, toys, flowers, clothing etc.) may provide a website which is accessible by computer terminals operated by various users. Such users may view the products and their corresponding descriptions on the computer terminals which the users operate. Using the computer terminal, the user chooses desired products for purchase and then purchases them, e.g., in a credit card transaction. The purchased items are then shipped to a shipping address specified by the user. Some sophisticated websites also provide for “registries”. For example, a website directed to wedding planning may also provide a facility for specifying a list of goods purchasable at the website and selected by the bride and groom. Other users may view this list and select items from the list for purchase in an electronic transaction. In yet another model, a first website with information of interest is not even operated by the e-commerce website. Rather, the website simply has display space set aside for visually displayed advertisements. Such advertisements may simply convey information regarding a product or service available at another company. Preferably, such advertisements include a hypertext link which is easily activated and which automatically “brings” the user to (i.e., causes the user's terminal to retrieve, for display at the user's computer terminal, information from) the website of another company, which may be an e-commerce website.

It is an object of the present invention to provide e-commerce capability to a consumer use netcast website.

So-called “webcam” websites exist which can be accessed by remote computer terminals executing a browser application. These websites usually have a camera that periodically, according to some timer schedule, captures still pictures and makes them available for download via the Internet to the remote terminals. Such webcam websites, however, do not allow the users of the remote terminal to compose the subject matter imaged by the still cameras. Moreover, the camera view depicted by the camera of the webcam website is entirely chosen by the webcam website operator. This operator typically allows anyone to download and view the captured still pictures but provides no editing tools for such pictures.

Many individuals have computer terminals which lack all of the features for capturing, editing and selectively distributing still pictures to others. Even when individuals have a basic system for capturing video, such a system is usually located at home or at work. However, it is often desirable to capture images at a specified location other than where the individual's terminal is located, such as a hospital. That is, if the image to be captured is of a subject confined to a location, then the individual's remotely located computer terminal cannot be used. This is especially true if the image to be captured is time sensitive, such as how a newborn baby appears at, or shortly after, birth, or how an injury of a patient appears at a given moment. It is another object of the present invention to facilitate such capture, editing and distribution of still pictures.

### SUMMARY OF THE INVENTION

These and other objects are achieved according to the present invention. An illustrative environment of use of the present invention is a publicly accessible wide area network, such as the Internet. Connected to this publicly accessible wide area network may be one or more of the following: patron user nodes, guest user nodes, registration nodes, scheduler nodes, operator nodes, distribution nodes and codec (e.g., “kiosk”) nodes. Although each node is illustrated as being a single purpose, individual node, it is possible that given hardware and software constituting a single node may perform the role of more than one of these nodes. For instance, a given node may play the role of the registration node, scheduler node and distribution node. Likewise, a given node may play the role of a patron user node and a guest user node, depending on the particular netcast in question.

According to one embodiment, a system and method are provided for facilitating capture and distribution of digital still pictures. A first node (e.g., a codec/kiosk node) has a camera, and a device capable of receiving user instructions (e.g., mouse and/or keyboard). The first node enables a patron user to capture one or more of images depicted by the camera as still pictures by providing the appropriate user instruction to the device capable of receiving user instructions. The first node transfers one or more of the captured still pictures to a second node (e.g., a distribution node) via a publicly accessible wide area network. The second node transfers via the publicly accessible wide area network copies of one or more of the captured still pictures to a third node (e.g., a patron user node) for display at the third node. The second node also receives via the publicly accessible wide area network at least one instruction from the third node designating one or more versions of still pictures derived from the captured still pictures to be accessible by non-patron users (e.g., guest users). The second node enables transfer via the publicly accessible wide area network only copies of the one or more versions of the still pictures derived from the captured still pictures (i.e., not other still pictures contained at the second node), to each node with permission to receive such versions of the still pictures other than a node validated by the second node as being operated by the patron user.

Illustratively, the third node (patron user node) is operating a browser program. When accessing the digital still pictures, the second node (distribution node) can transfer an executable software layout tool to the third node which the third node can execute in conjunction with the browser application. This software layout tool can be used by the patron user at the third node to edit the still pictures to generate the versions of the still pictures which are accessible to the guest users.

In addition, an e-commerce node can transfer targeted (audibly and/or visually) presentable advertisements, solicitations, hypertext links, etc. which can be presented by the browsers of users who attempt to retrieve still picture data from the second (distribution) node. Illustratively, the advertisements, solicitations, hypertext links, etc. are targeted to the presumed user (e.g., patron, guest or other user) of the node.

### BRIEF DESCRIPTION OF THE DRAWING

FIG. 1 shows a publicly accessible wide area network according to an embodiment of the present invention.

FIG. 2 shows a node according to an embodiment of the present invention.

FIGS. 3, 8, 12 and 15-16 show flowcharts illustrating a process according to an embodiment of the present the invention.

FIGS. 4-7, 9-11 and 13-14 show screen shots of presentable web pages according to an embodiment of the present invention.

FIGS. 17-18 show flowcharts for enabling capture, editing and distribution of still pictures according to the invention.

### DETAILED DESCRIPTION OF THE INVENTION

The present invention is illustrated herein for a live broadcast program which is receivable by other nodes at arbitrary geographic locations via a publicly accessible wide area network. In the illustration below, the publicly accessible wide area network is presumed to be the Internet. The live broadcast program is presumed to be a compressed audio-video program, i.e., a live audio-video signal, having a definite start time and a definite stop time (commonly referred to as an audio-video “event”). Of course, the program can be any schedulable streamed signal, i.e., a signal which must be delivered to a playback/decoder/presentation device at a particular rate to avoid discontinuities, buffer exceptions, etc. Furthermore, the invention is illustrated using Windows Media Encoder™ and Windows Media Player™, as program encoder and decoder/presentation applications. Both of these products are available from a company called Microsoft Corporation™, located in Redmond, Washington. Of course, other encoders and decoders are possible using different software, different protocols, hardware encoders and decoders or some combination of these. Alternatively, the encoder and decoder may be dispensed with (if the communications bandwidth, and quality of service for communication of the program, are sufficiently high).

In addition, the invention is illustrated in the context of a website oriented towards newborn babies. However, the invention is applicable in other contexts as may be appreciated by those skilled in the art.

FIG. 1 shows a communication network I including a publicly accessible wide area network 3, namely, the Internet, a collection of user nodes 5, operator nodes 7, web server facilities 9, and netcast facilities 11. The web server facilities 9 are shown as including registration nodes 13, scheduler nodes 15, distribution nodes 17 an e-commerce nodes 19. The netcast facilities 11 are shown as having codec nodes 21. The codec nodes illustratively are implemented as “kiosks” and are hereinafter described as codec/kiosk nodes 21. Of course, the particular implementation of a codec need not be a kiosk, but can take another form including a distributed system of separate parts (camera, monitor, computer, etc.) in communication with one another.

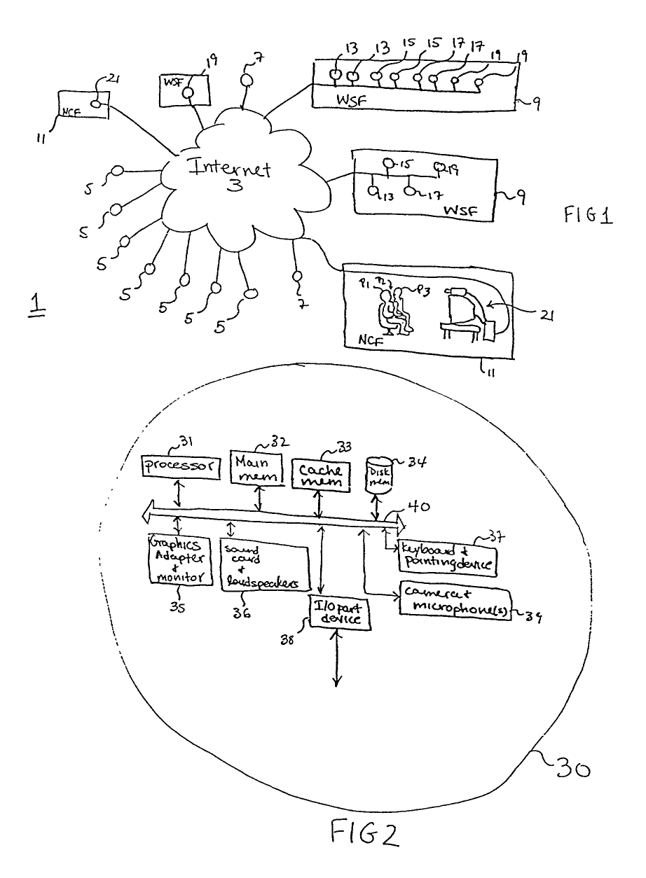

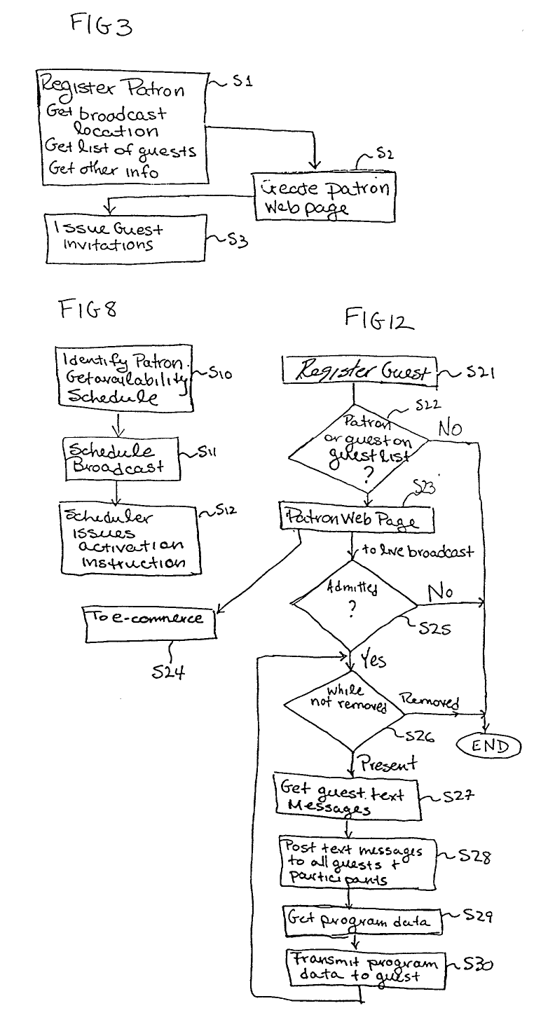

FIG. 2 shows an illustrative node 30 which can be a user node 5, an operator node 7, a registration node 13, a scheduler node 15, a distribution node 17, and e-commerce node 19 or a codec/kiosk node 21. The node 30 illustratively is in the form of a computer, such as a PC compatible computer. The node 30 illustratively includes a processor 31, a main memory 32, a cache memory 33, a disk memory 34, a (graphics adapter and) video monitor 35, (a sound card and) loudspeakers 36, a keyboard and pointing device (e.g., mouse, pointing stick, track pad, track ball, joystick, light pen, etc.) 37, an I/O port device (e.g., a modem, network interface card, etc.) 38, a camera and microphone(s) 39 and a bus 40.

The processor 31 is for executing instructions of a software application. The main memory 32, cache memory 33 and disk memory 34 are for storing the instructions of the software applications and data on which such software applications operate. Examples of such software applications include operating systems, web browsers, program encoders, program decoders/presentation applications and web server applications. Examples of data include web pages, programs and text.

The (graphics adapter and) video monitor 35 is for producing displayable images on the screen of the video monitor 35 based on data (such as web pages, text and video data) in the node 30. The (sound card and) loudspeakers 36 are for generating audible sounds, e.g., speech, music, etc., based on data (such as web pages, and audio sound) in the node 30. The video monitor 35 and loudspeakers 36 may also be provided with video and audio decoder hardware not shown. Collectively, the video monitor 35 and loudspeakers 36 are presentation devices of the node 30.

The keyboard and pointing device 37 are for receiving manual input from a user and/or operator such as keystrokes and point and click commands. Such data may constitute text to be communicated in a message, browsing/navigating instructions for use in operating a browser, etc.

The I/O port device 38 is for communicating signals between the nodes 30 and another device. For example, the I/O port device 38 can be a modem or a network interface card (Ethernet card). Without loss of generality, the I/O port device 38 can be a device for communicating between the node 30 and another device on a local area network or can be a device for communicating between the node 30 and the Internet 3. While a single I/O port device 38 is shown, several I/O port devices may be present in the node 30 and need not be of the same type.

The camera and microphones 39 are for capturing audio and video signals in a proximity to the placement of the camera and microphones 39 (typically near the node 30). In the present invention, the camera and microphones 39 illustratively used at the codec/kiosk nodes 21 are for capturing video and audio signals of, for examples, participants P1-P3, at a netcast facility 11.

The bus 40 is for communicating instructions and data amongst the devices 31-39 connected to the bus. The bus 40 is illustrated as a single bus, but may in fact be a hierarchical arrangement of busses to which various ones of the devices 31-39 are connected. In such a case, “bridges” are provided for connecting the busses.

The specific types of components 31-40 in the node 30 may vary to suit a specific role to be played by the node and certain components 31-40 not needed may be omitted in a specific node. Typically, the adaptation to suit a role is usually achieved by providing suitable software on the node. However, a node 30 may be adapted to play a specific role by providing a component 31-40 with adequate capacity (e.g., speed, size) or providing multiple components 31-40 within a specific node.

Amongst other things, the nodes 5, 7, 13, 15, 17, 19 and 21 are capable of transmitting packets to other nodes located geographically locally or remotely. Remote communication involves communication of messages in packets via the Internet 3. Each node 5, 7, 13, 15, 17, 19 and 21 may be provided with suitable communication software applications to achieve this end. For example, the nodes may execute Internet Explorer™ (a web browser application) or Microsoft-IIS (a web server application) distributed by Microsoft Corporation™.

The construction of the Internet 3 is not shown for sake of brevity. Generally stated, the Internet 3 is an interconnection of a plurality of private networks maintained by network access providers (NAPs) and Internet service providers (ISP), wherein the interconnection of the networks may be carried by various high capacity (i.e., T1, T3, T4, OC-3, OC-48, etc.) privately leased lines of the telephone network. Communication is achieved in the Internet using a hierarchy of protocols, including the Internet protocol (IP), the transmission control protocol (TCP), and the hypertext transfer protocol (http). Amongst other things, the Internet 3 can carry (in packets) messages for requesting information, and such requested information, from a source node to an appropriate destination node. For example, nodes can “visit web sites” and present “web pages” by issuing queries to specific web servers for web page information. The web servers respond by transferring the requested web page data to the requesting nodes. As the construction and operation of the Internet is conventional, its details are not described further.

The netcast facility 11 is shown as having a codec/kiosk node 21 and participants P1-P3. Illustratively, the netcast facility 11 is a video conferencing room suitable for capture of live audio and video. However, in another embodiment, the codec/kiosk node 21 is portable and can be moved from room to room as needed.

The web server facility 9 is shown as having different collections of registration nodes 13, scheduler nodes 15, distribution nodes 17 and e-commerce nodes 19. The specific roles played by each of these nodes are described in greater detail below. The particular number of each type of node can be varied from facility to facility. For example, the e-commerce nodes 19 may be located at web server facilities 9 geographically remote from the web server facilities containing the other nodes 13, 15 and 17. Also, it is possible to have a single node which plays one or more of the roles of the registration node 13, scheduler node 15, distribution node 17 and e-commerce node 19. When implemented as separate nodes, each of the separate nodes preferably is connected by a local area network at the web server facility. Also, while shown located outside the web server facility 9, some or all of the operator nodes 7 may be present at the web server facility 9.

In the invention, different kinds of nodes play different roles. These roles are summarized as follows. A user node 5 is a node operated by a guest user or a patron user. A patron user is a user who registers for a live netcast. The patron user specifies the location of the live broadcast and which guests may view the netcast. The guest users are users who may view the netcast. Both the patron user and guest users may also participate in e-commerce transactions including viewing advertisements, visiting web sites of advertisers and purchasing goods and services of advertisers in electronic transactions. Illustratively, the guest user nodes 5 and patron user nodes 5 are PC compatible computers which execute Internet Explorer™. The guest user nodes 5 preferably also execute a decoder/playback/presentation software application such as Windows Media Player™. Also, user nodes 5 are shown as being directly connected to the Internet 3. Typically, each user node 5 is a standalone PC computer connected to the Internet 3 by a dial-up service provider (such as AOL™) or a cable service provider (such as Road Runner™). However, these nodes may also be part of campus or enterprise local area networks, which in turn are connected to the Internet 3.

The registration node 13 is for enabling a patron user to register for a netcast. The registration node 13 issues appropriate displayable entry forms, e.g., in the form of web pages, that can be “filled out” by the patron user. The registration node 13 also issues email invitations to specified guests user nodes 5.

The scheduler node 15 is for scheduling and activating the netcast. Scheduling may be performed in conjunction with an operator node 7 operated by an operator. That is, in the application of a netcast for newborn babies, the patrons are typically the parents of the newborn baby. The scheduling of the netcast typically occurs soon after the newborn baby is born. Since the parents are often confined to the hospital at this time, a procedure is provided to nevertheless enable the parent-patrons to schedule the netcast despite lack of access to a node. Specifically, the parent-patrons can contact an operator via telephone and provide instructions for scheduling the netcast. The operator, which may be a human user, views a schedule of netcasts to occur and indicates available times for the netcasts. The parent-patrons communicate their selected time to the operator who enters such information at the operator node 7. The schedule is communicated to the scheduler node 15 which schedules the netcast. Specifically, the scheduler node 15 transmits instructions to the appropriate codec/kiosk node 21 for initiating the netcast at the scheduled time.

The distribution node 17 receives commands from guest user nodes 5 requesting to participate in the netcast. The distribution node 17 allows selected guest user nodes 5 to participate in the netcast if they were indicated as invited by the patron user. The distribution node 17 receives textual messages from each guest user node 5 and transmits such textual messages for display on each other participating guest user node 5 and the codec/kiosk node 21. The distribution node 17 also transmits a program generated by the codec/kiosk node 21 to each of the participating guest user nodes 5.

The e-commerce node 19 is a node which provides commerce information. The commerce information may simply be an advertisement. However, the commerce information preferably includes a manner of conducting an electronic transaction, e.g., a purchase of goods or services.

Given this configuration, the operation of the invention is now described. Herein, reference will now be made to nodes by their role, without distinguishing whether or not two or more nodes are actually implemented on a single hardware device (PC) or multiple hardware devices.

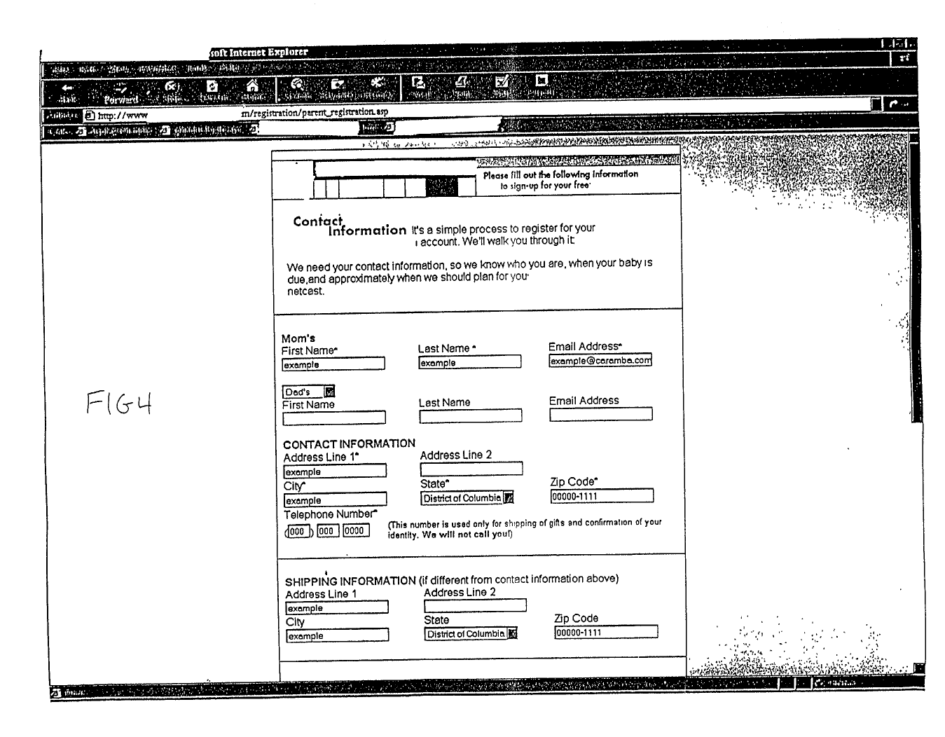

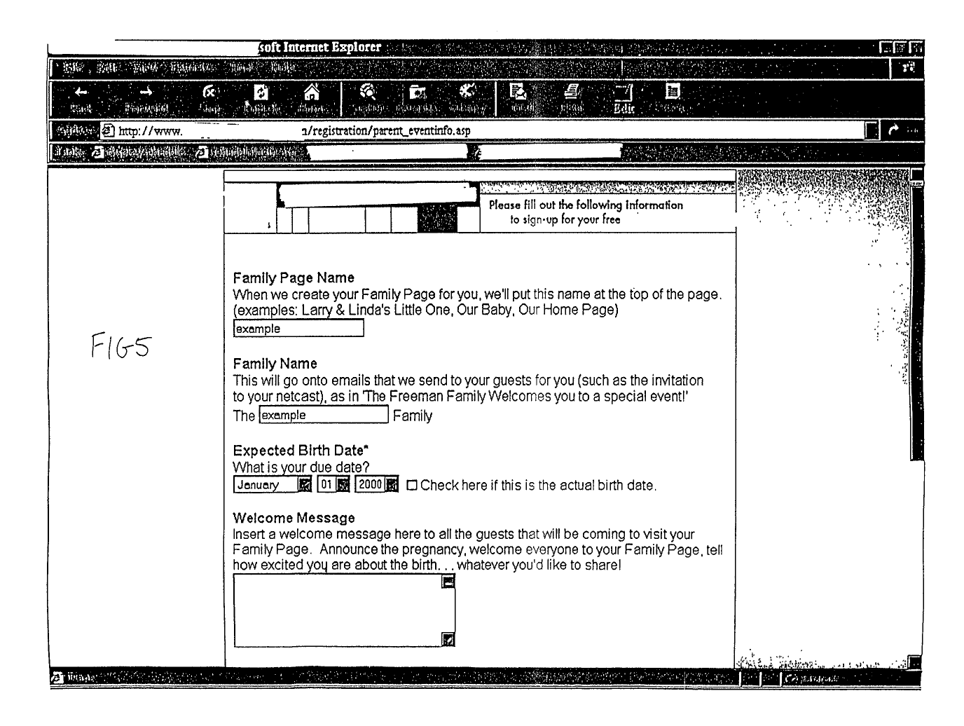

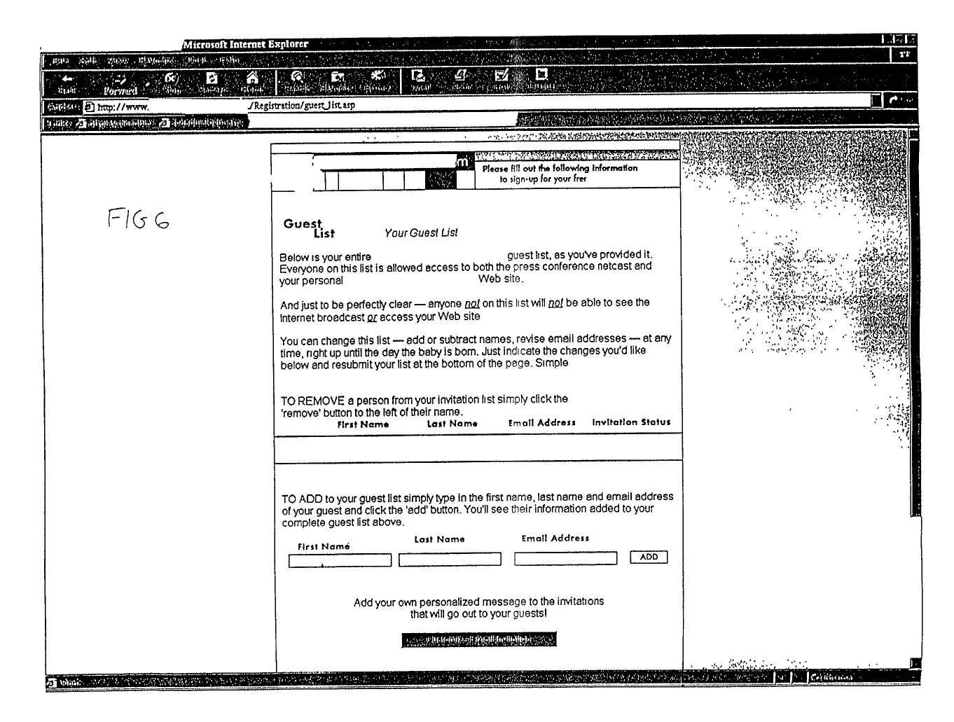

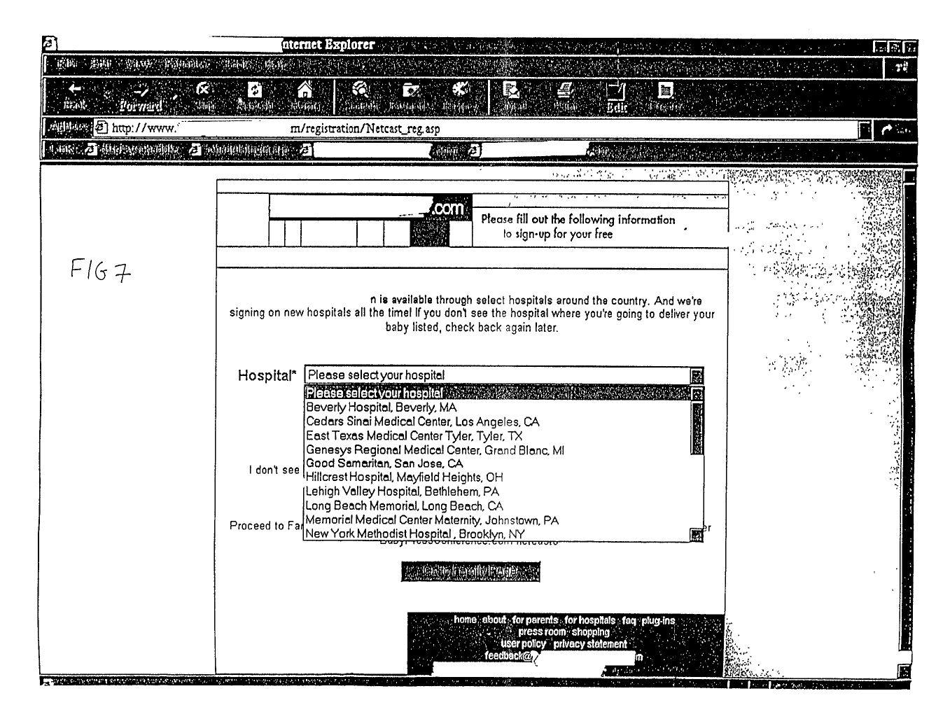

In FIG. 3, a patron user operating a patron user node 5 executes the web browser software application and “visits” i.e., accesses and displays the information at a web site at which a live netcast can be ordered. To do so, the web browser software causes the I/O port device 38 (FIG. 2) to issue one or more messages (in packets) to the appropriate registration node 13 (namely, the registration node 13 appointed to respond to messages addressed to a particular uniform resource locator (URL) address). In step SI, the appropriate information for registering the live broadcast web site is obtained from Z the patron user node 5 at the registration node 13. To that end, the registration node 13 transmits messages and data suitable for constructing a web page in packets back to the I/O port device 38 (FIG. 2) of the patron user node 5. The I/O port device 38 (FIG. 2) receives such packets and provides the messages to the processor 31 (FIG. 2) of the patron user node 5. While executing the web browser software application, the processor 31 (FIG. 2) generates suitable instructions for causing the video monitor 35 (FIG. 2) and loudspeakers 36 to present the web page, i.e., to display on the monitor 35 the visual information and to generate on the loudspeakers 36 audible sounds of the web page. Illustratively, the web page includes fields for filling in information such as: (1) billing information, i.e., the name(s) of the patron(s), the address and phone number of the patron(s), a shipping address of the patron(s); (2) information for generating a web page specific to the patron, such as the expected due date for the newborn baby, a welcome message for a family web page (described in greater detail below); (3) names of guests to be invited to the live broadcast; and (4) selectable locations at which the live broadcast can be held. FIGS. 4-7 show illustrative screen shots of web pages displayed at the patron user node 5 for obtaining the above information.

Next, in step S2, the registration node 13 creates a patron specific web page using the information provided by the patron user node 5. In step S3, the registration node 13 issues an e-mail message to each guest (node 5) listed or indicated by the patron user. The e-mail message illustratively indicates instructions for accessing the patron's web page and for participating in the live netcast.

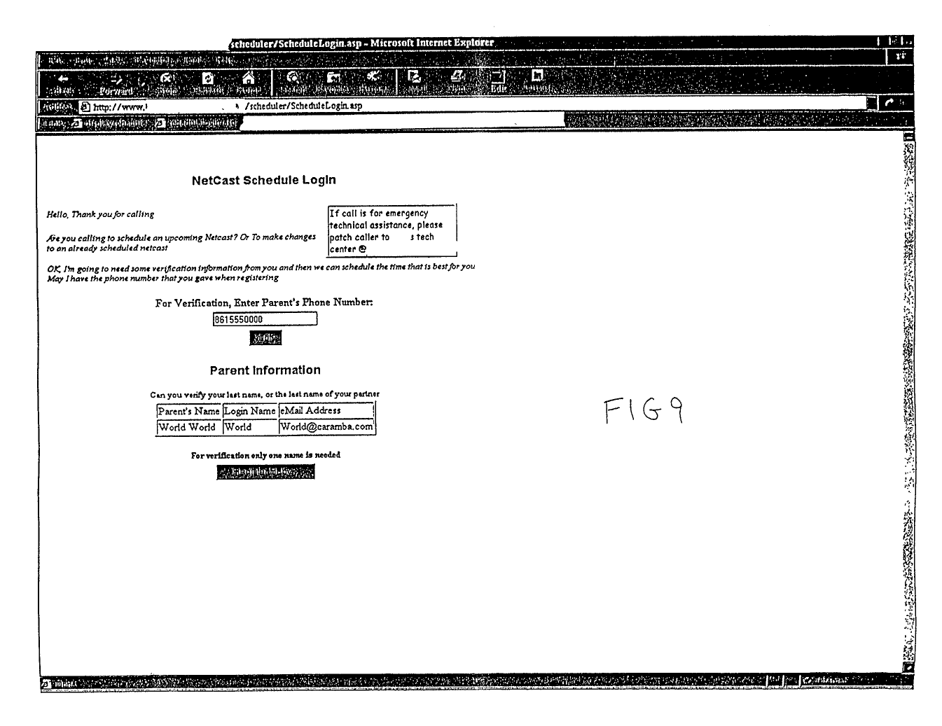

When it is desired to schedule the netcast, the process shown in FIG. 8 is performed. In this process, the patrons contact an operator via telephone. Illustratively, the operator is a human operator although an automated operator is also possible. In addition, it is also possible to allow the patron user to operate an operator node 7 to schedule a netcast, if such an operator node 7 is available.

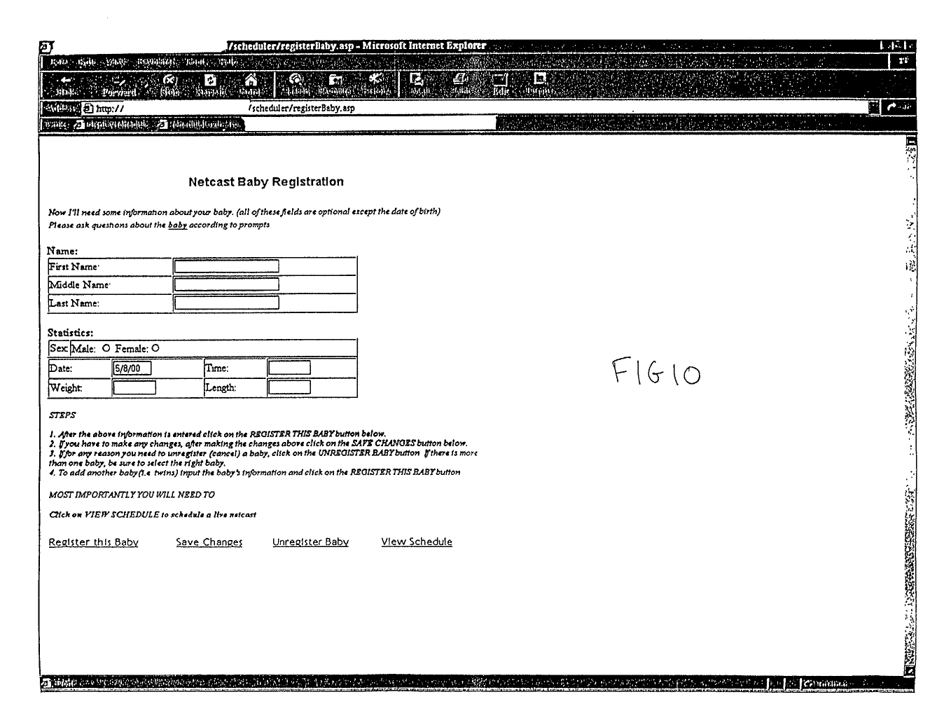

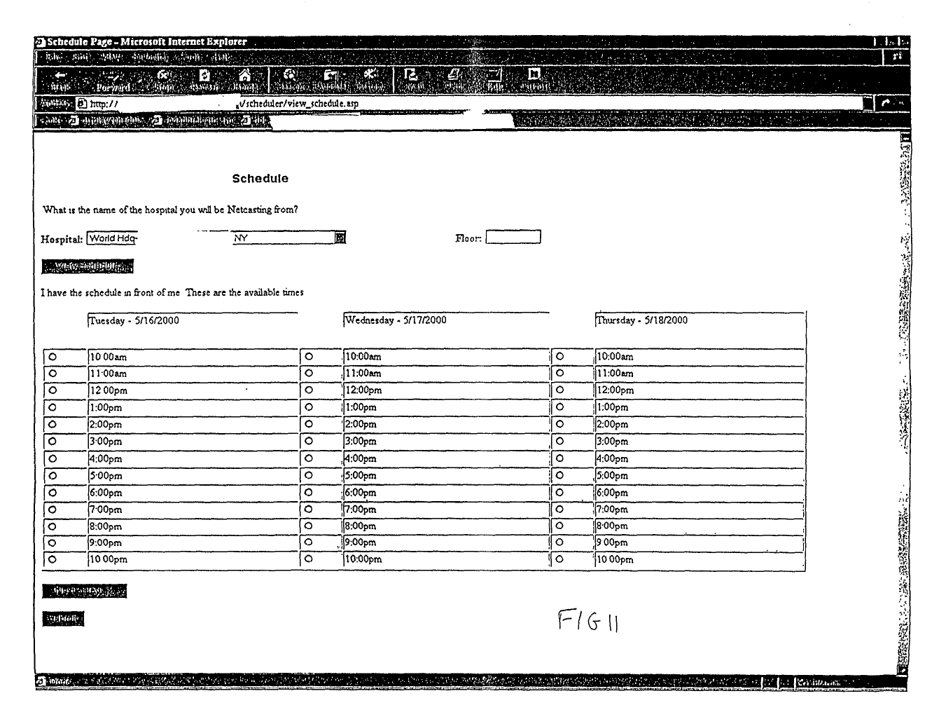

The operator operates an operator node 7. In step S10, the operator identifies the patrons. Since security risks are not very high for scheduling a netcast, the telephone number of the patrons may be sufficient for identifying them. Some other information, such as the last name, login name and email address of one of the patrons may be used for verification purposes. If security risks are greater, and more assurance of identity is needed, passwords and other measures may be employed. Using the operator node 7, the operator obtains various web pages provided by an appropriate one of the scheduler nodes 15. These web pages depict forms for assisting the operator in scheduling the netcast. The operator is prompted to enter information for identifying, and verifying the identity of, the patrons. The operator is also prompted to enter other information of interest to the guests, such as the name(s) of the baby (or babies), sex(es), birth date(s), weight(s), length(s), etc. FIGS. 9-10 illustrate screen shots of forms which can be transmitted from the scheduler node 15 to, and presented at, the operator node 7 to obtain the requisite identity and vital statistics data.

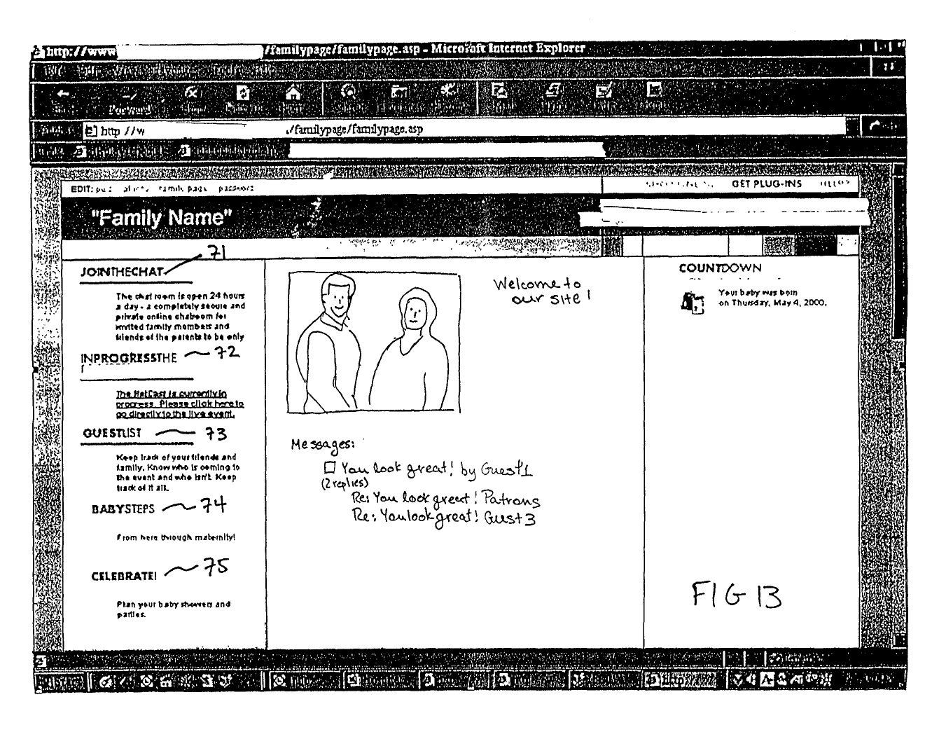

Next, in step S11, the operator schedules the netcast. Under direction of the patrons, the operator selects one of a list of available netcast locations at which the netcast is to be held. In this application, the netcast is a specific video conference room at the hospital or birthing center. Note that a given hospital may have several codec/kiosk nodes 21 for performing a netcast. The appropriate codec/kiosk node 21 must be selected. The codec/kiosk node 21 selected should be associated with an identifying (e.g., ID) code or other information that corresponds or points to, among other things, the location of the codec/kiosk. FIG. 11 shows a screen shot of a web page which can be transmitted from the scheduler node 15 to, and presented at, the operator node 7 for scheduling the netcast at a particular available time and location.

The operator supplies the requisite information and the operator node 7 transmits the schedule information to the scheduler node 15. In step S12, the scheduler node 15 supplies appropriate instructions to the appropriate codec/kiosk node 21 for initiating and ceasing the scheduled netcast. This is described in greater detail below.

FIG. 12 illustrates a process executed when a guest desires to access the patron web page. The guest can access the patron web page before, during and after the netcast. Of course, the guest user can only participate in the netcast while it is occurring. In step S21, while executing the web browser software application, the processor 31 (FIG. 2) in the guest node 5, causes the I/O port device 38 (FIG. 2) to transmit a message to the appropriate distribution node 17. The appropriate distribution node 17 is the one designated to respond to the URL of the message issued by the guest node 5. In response, the distribution node 17 transmits to the guest node 5 in packets, messages containing control information and data of a web page for, amongst other things, logging on to a patron web page. These messages are received at the I/O port device 38 (FIG. 2) of the guest node 5 and are provided to the processor 31 (FIG. 2) of the guest node 5. The processor 31 (FIG. 2) causes the monitor 35 (FIG. 2) and loudspeakers 36 (FIG. 2) to present the web page. In response, the guest user uses the keyboard and pointing device 37 (FIG. 2) for providing the appropriate identifying information for logging on to a particular patron web page. The processor 31 (FIG. 2) causes the I/O port device 38 (FIG. 2) to transmit this information to the distribution node 17.

Next, in step S22, the distribution node 17 determines if the guest is on the guest list, and therefore permitted to access the patron's web page. To that end, the distribution node 17 compares the information provided by the guest node 5 to the list of guests invited by the patron. Identifying information can be any combination of post address, email address, phone number, etc. of the guest. If the identifying information provided by the guest node 5 matches identifying information in the list generated by the user, the guest may access the patron's web page. If not, the distribution node 17 refrains from delivering any information regarding the patron's web page or netcast to the guest node 5.

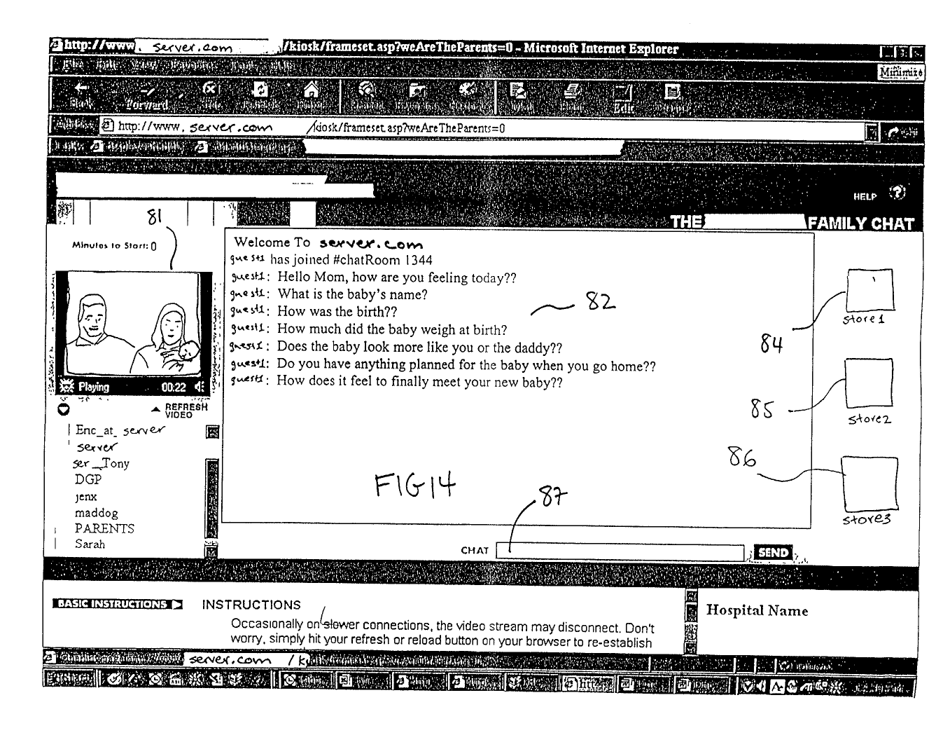

Assume that the guest provides appropriate matching identification information which matches that of a guest on the guest list provided by the patron user. If so, then in step S22, the distribution node 17 transmits to the guest node 5 the patron's web page generated by the registration node 13 in step S2. The web page is received as messages by the I/O port device 38 (FIG. 2) and the processor 31 (FIG. 2) that cause the monitor 35 (FIG. 2) and loudspeakers 36 (FIG. 2) to present the patron web page. FIG. 13 shows a screen shot of such a patron web page. As can be seen, the patron web page has a number of hypertext links 71-75, including a hypertext link 71 to a chat room, and a hypertext link 72 to the netcast.

One or more of the hypertext links may also lead to an e-commerce web page provided by an e-commerce node 19. For example, hypertext link 75 pertaining to planning a celebration may have a component allowing the patron user to specify a registry or list of gifts to be purchased for the newborn baby. These gifts may be chosen from a list of gifts available from an e-commerce proprietor. A guest user node 5 executing this link 75 (step S24 of FIG. 12) may cause the presentation of a web page with the list of gifts on the registry and the ability to make an electronic purchase of such gifts by filling out an appropriate form on the retrieved web page.

Assume now that the guest user executes link 72 leading to the netcast. Also assume that the netcast is in progress. The guest user uses the keyboard and pointing device 37 (FIG. 2) of the guest node 5 to select the link 72. The processor 31 (FIG. 2) of the guest node 5 causes the I/O port device 38 (FIG. 2) of the guest node 5 to issue a message indicating this selection.

The message requesting that the guest user be admitted to the netcast is received at the distribution node 17. In step S25, the distribution node 17 transmits a message to the codec/kiosk node 21 at which the netcast is occurring indicating that the particular guest wishes to join the netcast. The codec/kiosk node 21 displays on the monitor 35 (FIG. 2) to the netcast facility participants (P1-P3) the identity of the guest user who wishes to join. If the netcast facility participants (P1-P3) desire that this guest be allowed to participate in the netcast, the netcast facility participants (P1-P3) issue an instruction, e.g., by the pointing device 37 (FIG. 2) of the codec/kiosk node 21. This causes an instruction to be transmitted from the (I/O port device 38 of the) codec/kiosk node 21 to the distribution node 17 admitting the guest. Note that at any time, the netcast facility participants (P1-P3) may remove a guest with a similar process in step S26, which causes an instruction to be transmitted from the codec/kiosk node 21 to the distribution node 17 indicating that the guest is to be removed.

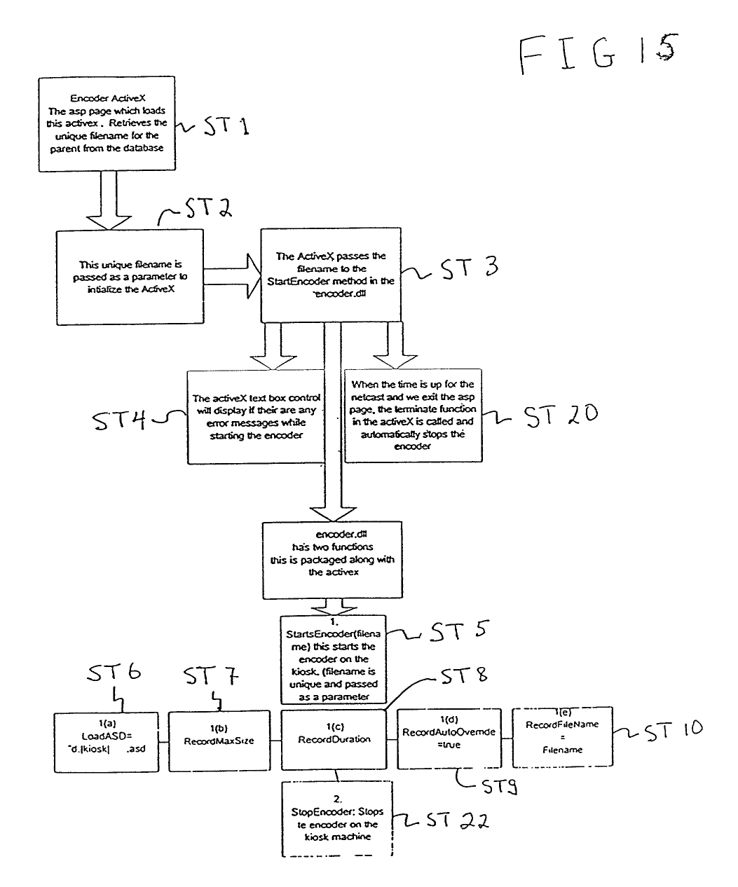

In steps S25 and S26, the distribution node 17 verifies that the guest has been admitted, and currently has not been subsequently removed, by the participants at the netcast facility (P1-P3). So long as the guest has not been removed, steps S27-S30 are carried out (until the netcast ceases). To fully understand the operation during a netcast, refer to FIG. 14 which shows a web page that is presented at a guest node 5 while participating in a netcast. A real-time video window displays decoded, presented video of a program signal captured and encoded by the codec/kiosk node 21, transmitted to the distribution node 17 and transmitted from the distribution node 17 to participating guest nodes 5. Although not shown in FIG. 14, audio is also decoded and reproduced by the loudspeakers 36 (FIG. 2) of the guest nodes 5 from this program signal. In a window 82, textual messages generated by each guest are displayed. If desired, a participating guest may type a textual message into field 87 using the keyboard and pointing device 37 (FIG. 2) of the guest node 5. This text is transmitted to the distribution node 17 (step S27). In response, the distribution node 17 transmits a copy of the text to all participating guest nodes 5 and to the codec/kiosk node 21. The text is received at (the I/O port device 38 (FIG. 2) of) each of these nodes 5, 21 and is presented at (e.g., by the monitor 35 (FIG. 2) of) each of these nodes 5, 21 in field 82 (or a similar field on the codec/kiosk node 21, not shown). The netcast facility participants (P1-P3) see the text and respond with visual and audible information (i.e., they speak their replies or gesture/show objects to the camera and microphone(s) 39 (FIG. 2)). The video and audio are encoded by an encoder of the codec/kiosk node 21 and are transmitted by the I/O port device 38 (FIG. 2) to the distribution node 17. Thus, in step S29, the distribution node 17 gets the program signal data from the codec/kiosk node 21. In step S30, the distribution node 17 transmits a copy of the program data to each admitted participating guest node 5 not removed by the netcast facility participants. The program signal data is received at the I/O port device 38 (FIG. 2) of each such guest node 5 and the processor 31 (FIG. 2) decodes the audio and video of the program signal. The processor 31 (FIG. 2) then causes the decoded audio and video to be presented by the monitor 35 (FIG. 2) and loudspeakers 36 (FIG. 2). The decoded video pictures are displayed in window 81.

Of course, if the netcast facility participants (P1-P3) remove a guest, the distribution node 17 ceases to provide program signal data to the guest node 5 of that guest. Also, at the end of the netcast session, the distribution node 17 ceases transmission of the program signal to the guest nodes 5.

Note that the web page of FIG. 14 has icons 84-86 corresponding to e-commerce merchants. These can be advertisements but preferably are hypertext links to an e-commerce node 19. At all web pages the type of e-commerce solicited to the user is preferably geared to the presumed interests of the user. For instance, advertisements and hypertext links for e-commerce goods and service(s) appealing to a patron (e.g., child care services) are presented as part of web pages likely to be accessed by patrons. Likewise, advertisements and hypertext links for e-commerce goods and service(s) appealing to a guest (e.g., flowers, toys, stuffed animals, etc.) are presented as part of web pages likely to be accessed by guests.

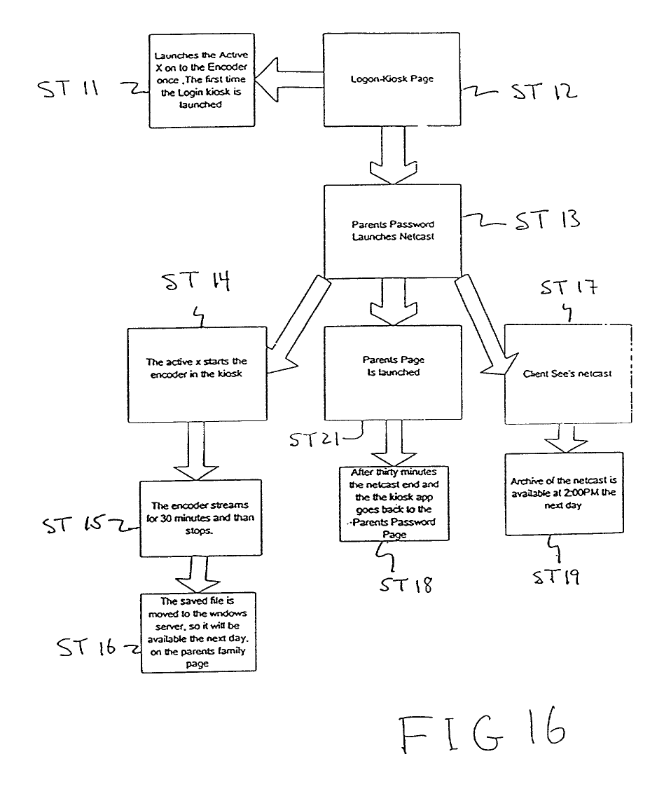

The following is a more detailed description of the process by which the netcast is scheduled and activated automatically. As mentioned in connection with FIG. 3, patron users register for a netcast. The information obtained from the registration node 13 needed to schedule the netcast (i.e., information identifying the patrons and the netcast venue) is transmitted from the registration node 13 to the scheduler node 15 (assuming they are different devices). The scheduler node 15 stores this information in a file in the memory 32, 33 or 34 (FIG. 2). Next, in FIG. 8, the patron users schedule the netcast. The processor 31 (FIG. 2) of the appropriate scheduler node 15 performs step STI of FIG. 15. In this step, the processor 31 (FIG. 2) of the scheduler node 15 retrieves from its memory 32, 33 or 34 (FIG. 2) the file (or record) corresponding to the information regarding the patron user which was produced by the registration node 13 during registration.

Illustratively, the processor 31 (FIG. 2) also activates an ActiveX™ (ActiveX™ being a genre of processes created by Microsoft Corporation™) process and passes the file to the process (step ST2). In so doing, the ActiveX™ process passes the file to a process labeled “StartEncoder” (step ST3). If there is an error in so doing, an error message is logged and a human operator is notified in step ST4.

A timer is engaged which causes the scheduler node 15 to automatically activate the remotely located codec/kiosk node 21 at the scheduled time. Specifically, as shown in steps ST5-ST6, at the appropriate time, the processor 31 (FIG. 2) of the scheduler node 15 transmits a command to the codec/kiosk node 21 to activate. (Illustratively, the command is transmitted using remote control functions of ActiveX™, which in turn, are carried in packets across the Internet 3 according to the Internet protocol.) Alternatively, the command is sent prior to the scheduled netcast and the codec/kiosk node 21 operates a timer, and activates the netcast at the scheduled time. In addition, the scheduler node 15 or registration node 13 may transmit an email message to each invited guest node 5 informing the guests of the scheduled time for the netcast.

The user nodes 5, operator node 7, registration node 13, scheduler node 15, distribution node 17, and codec/kiosk node 21 may be in different time zones. Thus, any time differences, including daylight savings time, between these nodes should be taken into account. Illustratively, the scheduler node 15 may account for the time differences. Most notably, when the scheduler node 15 and the codec/kiosk node 19 are in different time zones (perhaps even in different countries), the scheduler node 15 must start the netcast at the code/kiosk node 19 at the correct time. Generally speaking, the start time schedule specified by the patron user (in conjunction with the operator node 7) is relative to the time zone of the netcast facility 9 containing the code/kiosk node 21, whereas the start time is generated by the scheduler node 15 relative to its own time zone. To accommodate this problem, the scheduler node subtracts or adds the correct amount of time to reflect the time difference between the time zones of the scheduler node 15 location and the code/kiosk node 19 location.

Illustratively, the identifying information of the codec/kiosk node 21 selected for the netcast corresponds or points to location information of the codec/kiosk node 21. The location information illustratively includes corresponding time zone information or a pointer to corresponding time zone information for the time zone of the location of the respective codec/kiosk node 21 stored in a memory 32, 33, or 34 of, e.g., the scheduler node 15. The scheduler node 15 uses the time zone information to calculate and supply correct time zone adjustment information to the code/kiosk node 19 for starting the netcast at the correct scheduled time. In addition, the correct time information may also be supplied to the patron's web page and used to indicate the scheduled netcast time in the email messages informing the invited guests nodes 5 of the scheduled time for the netcast. For example, the scheduled netcast time indicated in the email message may also indicate the time zone of the netcast.

In any event, while the netcast is conducted, the processor 31 (FIG. 2) of the codec/kiosk node 21 obtains pertinent information pertaining to the netcast (steps ST7-ST10). At the appropriate time, the processor 31 (FIG. 2) of the scheduler node 15 transmits a command to the codec/kiosk node 21 to stop the video conference at step ST22. Alternatively, the command along with the necessary timing information may have been earlier communicated and stored in the memory 32, 33 or 34 (FIG. 2) of the codec/kiosk node 21.

At the time of the netcast, the parents and newborn baby go to the video conference room of the netcast facility 11 containing the particular codec/kiosk node 21 at which the netcast has been scheduled. Preferably, this is a dedicated room specially designed (in terms of lighting and acoustics) for an audio/video conference. Alternatively, the codec/kiosk node 21 may be portable and moved to the room of the parents/baby in the event that either is restricted to some location. Using the keyboard or pointing device 37 (FIG. 2), the parent/patrons are prompted to login to the codec/kiosk node 21.

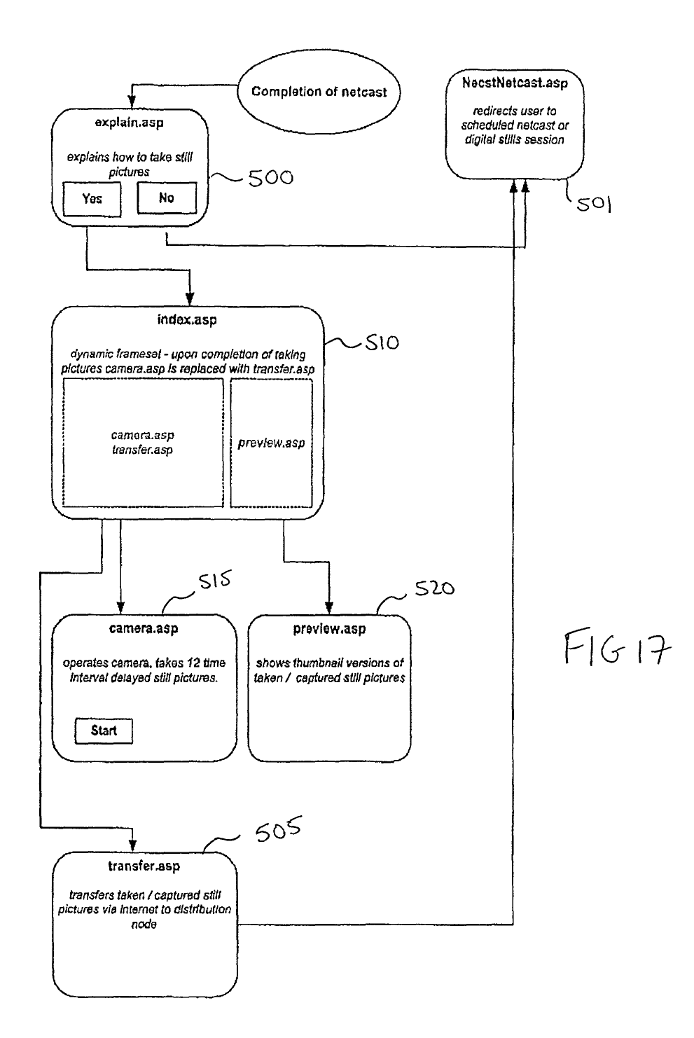

The following steps of FIG. 16 are carried out during the course of the netcast. Initially, when the codec/kiosk node 21 is powered-up, the ActiveXTM process is initialized by the processor 31 (FIG. 2) of the codec/kiosk node 21 and a login page is displayed on a monitor 35 (FIG. 2) of the codec/kiosk node 21 (steps ST11-ST12). The parents are prompted for their password (step ST13) which causes the following steps to be carried out. In step ST 14, the processor 31 (FIG. 2) of the codec/kiosk node 21 is started (automatically by the remotely transmitted instruction from the scheduler node 15 as per step ST5 of FIG. 15). In addition, in step ST21, the processor 31 (FIG. 2) of the distribution node 17 launches a netcast web page similar to FIG. 14 specific to this particular netcast which the guests may access. In step ST15, the processor 31 (FIG. 2) of the codec/kiosk node 21 executes a video/audio encoder (compressor) process. As a result, video captured by the video camera 39 (FIG. 2), and audio captured by the microphone 39 (FIG. 2) at the codec/kiosk node 21, are encoded (compressed) and streamed in real time as a program signal through the Internet 3 to the distribution node 17 at the web server facilities 9. In addition, the program signal of the netcast is recorded (i.e., at the codec/kiosk node 21 for later upload, or in real time at the distribution node 17). The recorded program signal is made available for retrieval via the patron web page shown in FIG. 13 from the distribution node 17 at a later time (ST16).

Moreover, the encoded video and audio are distributed via the Internet 3 from the distribution node 17 to the guest user nodes 5 “admitted” for decoding (decompressing), playback and presentation thereat. Specifically, as noted above, each guest node 5 accesses the specific patron web page of the corresponding netcast at the appropriate scheduled time (step ST17).

At the expiry of the scheduled netcast time, the distribution node 17 transmits a message for deactivating the netcast to the codec/kiosk node 21. This deactivates the encoder process executed on the processor 31 (FIG. 2) of the codec/kiosk node 21 thereby interrupting the encoded program signal. Alternatively, the message to deactivate the netcast along with the necessary timing information may have been transmitted earlier and stored in the memory 32, 33 or 34 (FIG. 2) of the codec/kiosk node 21. As shown in steps ST18 and ST 20, the netcast ends, and the codec/kiosk node 21 once again presents the initial login web page. The distribution node 17 then makes the recording of the program of the netcast accessible from the patron web page of that netcast (step STl9).

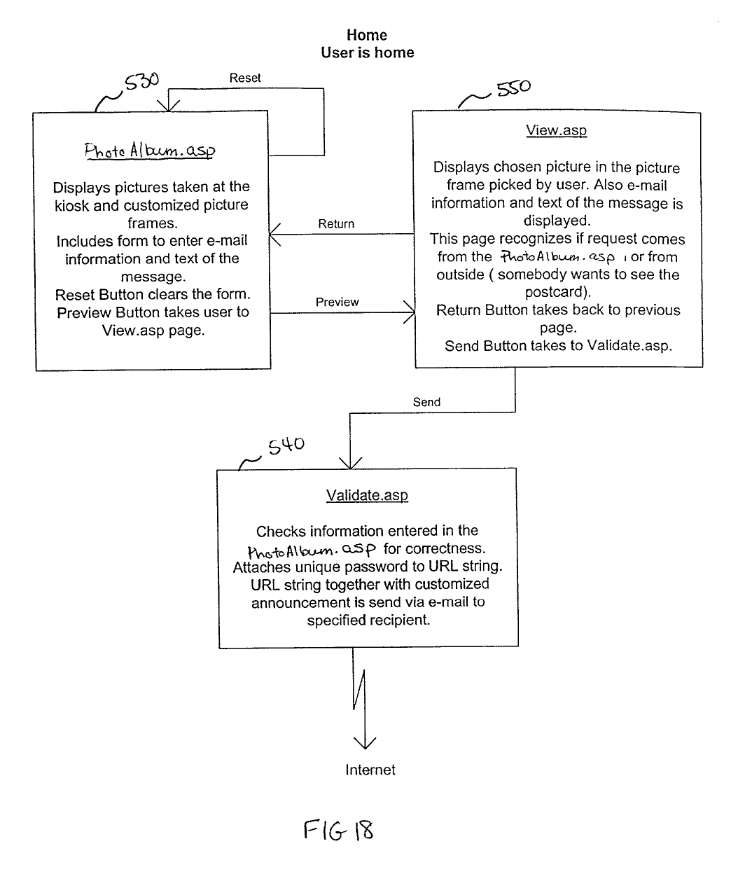

FIGS. 17-18 illustrate another invention. Illustratively, the invention is illustrated using the system 1 of FIG. 1. The invention described can be used in conjunction with the invention described above or can be used independently. Specifically, the invention described below enables the patron users or participants P1-P3 to capture still pictures.

Illustratively, the camera and microphone 39 at the kiosk/codec node 21 are implemented using the Osprey 500™ capture card distributed by ViewCast™, a company located in Dallas, Texas. Such a capture card is also capable of using the imaging device or camera 39 to capture still pictures as well as to capture moving pictures.

In the embodiment illustrated, the opportunity to take still pictures is provided at the completion of a netcast. Alternatively, it is possible to schedule digital still picture taking sessions in an analogous fashion as described above for netcasts. Initially, the kiosk/codec node 21 accesses a so-called access server page “explain.asp” 500 which is a form of web page including presentable data and embedded code. The “explain.asp” access server page provides (e.g., displays on the monitor 35 or audibly describes via the loudspeakers 36) instructions to the participants P1-P3 as to how to use the kiosk/codec node 21 to take still pictures. This access server page also provides the participants P1-P3 the ability to choose whether or not to use the still picture taking capability of the kiosk/codec node 19, e.g., in the form of (keyboard/pointer device 37) selectable “Yes” and “No” buttons (displayed on the monitor 35). If one of the participants P1-P3 selects “No”, then the active server page “NecstNetcast. asp” 501 is loaded at the kiosk/codec node 19 for purposes of redirecting these or other participants to the next netcast or digital still picture session. If one of the participants P1-P3 selects “Yes” (i.e., desires to take still pictures), then a so-called “frameset” active server page “index. asp” 510 is loaded including two active server pages, namely, “camera.asp” 515 and “preview.asp” 520. As before, a web page may be loaded by, for example, the kiosk/codec node 19 transmitting an instruction via the Internet 3 to the distribution node 17 requesting retrieval of the respective web page. The distribution node 17 responds by transferring the requested web page via the Internet 3 to the kiosk/codec node 19. The frameset and active server pages are web pages containing a combination of presentable data and embedded code. The active server page “camera.asp” 515 includes embedded code which actually operates the camera 39 to cause still pictures to be taken, in response to the participants P1-P3 beginning a still picture taking session. For example, a selectable button “Start” is displayed on the monitor 35 which the participants can select using the keyboard/pointing device 37. When selected, the “camera.asp” active server page 515 activates the camera 39 to capture still pictures on a time interval basis. Illustratively, the monitor 35 displays an image or message, such as “Smile [symbol] ”, to prompt the participants when each still picture is captured. Illustratively, the camera 39 and capture board capture each still picture in a well-known device for temporary storage, e.g., in the memory 32, 33 and/or 34. In one embodiment, a fixed number of still pictures are taken in this fashion.

Each time a still picture is captured, a thumbnail version of the captured still picture is displayed on the monitor 35 in the portion of the frameset associated with the active server page “preview.asp” 520. After the requisite number of still pictures are captured, the active server page “camera.asp” 515 unloads from the “index.asp” frameset 500 at the kiosk/codec node 19. The active server page “transfer.asp” 505 loads in place of “camera.asp” 515. The “transfer.asp” active server page 505 uses an ftp (file transfer protocol) process to transfer each captured still image via the Internet 3 to the distribution node 17 in a fashion which causes the pictures to be associated with the patron user information. This enables the distribution node 17 to store the still pictures in an SQL server, e.g., in a folder associated with the correct patron user. After transferring the captured digital still pictures, the access server page “NecstNetcast.asp” 501 is loaded on the kiosk/codec node 19 to enable these or other participants to participate in the next scheduled netcast or digital still picture taking session.

When the patron user returns to his or her patron user node 7, the patron user can access the captured still pictures stored at the distribution node 17 via the Internet 3. First, the patron user accesses the patron web page using the patron user's node 5. The patron user then logs-on and in so doing provides sufficient information (e.g., a password) for authenticating himself or herself as the patron user of the patron web page. The process for this access is similar to that described above in step S23 except that the patron user is recognized as having greater privileges than the guest users. The patron user then accesses his or her personal photo album of still pictures. More precisely, the patron user node 5 issues an appropriate command via the Internet 3 to the distribution node 17 for retrieving and executing/presenting an active server page, “PhotoAlbum.asp” 530. This causes the distribution node 17 to return the “PhotoAlbum.asp” active server page 530 for presentation and execution at the patron user's node 5.

The “PhotoAlbum.asp” active server page 530 is provided for displaying the previously taken still pictures and provides editing/layout tools as described below. A form is also included in “PhotoAlbum. asp” active server page 530 for entering the email addresses of recipients of various still pictures (e.g., as edited/laid-out). As is conventional, a reset button is provided for clearing the form.

Illustratively, when the patron user node 5 accesses active server page “PhotoAlbum.asp” 530, the distribution node 17 also returns thumbnail versions of the still pictures for display and selection (via the pointing device 37) by the patron user node 5. The patron user can select one of the thumbnail pictures. The patron user can then also select the preview button using the pointing device 37. In response, the patron user's node 5 loads the active server page “view.asp” 550 (which illustratively is transferred from the distribution node 17 to the patron user's node 5 via the Internet 3 in response to the activation command transferred by the patron user's node 5 to the distribution node 17 via the Internet 3). In activating this “view.asp” active server page 550, the patron user's node 5 transmits via the Internet 3 an instruction to the distribution node 17 to retrieve the selected still picture. In response, the distribution node 17 confirms whether or not the instruction was received from the “PhotoAlbum.asp” active server page 530 by a patron user with authority to access the requested still picture. If so, the distribution node 17 transfers the selected still picture to the patron user's node 5 via the Internet 3.

As noted above, the distribution node 17 determines whether a request to access a still picture was received from the patron user or from another person (as described in greater detail below). In the case of a patron user, the distribution node 17 also provides an editing environment for editing the still pictures. For example, the distribution node 17 can download or transfer to the patron user node (while the patron user node 5 executes the browser application) an executable software layout tool application (which illustratively can be executed in conjunction or simultaneously as the browser application at the patron user node 5) for cropping, coloring, resizing and/or deleting the still pictures. Illustratively, tools are also provided to enable the patron user to make electronic postcards, notes, etc. As a further enhancement, designed borders or frames are provided for ornamenting the still pictures which the patron user can select. The patron user can also add text to individual still pictures. Illustratively, the editing/layout software application tools are provided in the “PhotoAlbum. asp” active server page 530 and the final edited/laid-out version of a still picture is displayed using the “view.asp” active server page 550. The patron user can also print out copies of the still pictures as edited/laid-out using a printer (not shown in FIG. 2) attached to the patron user's node 5 and can designate an edited still picture version as complete and ready for access (as described below).

By virtue of performing edit or lay-out operations, the patron user's node 5 transmits edit commands to the distribution node 17 via the Internet 3. In response, the distribution node 17 creates and edited/laid-out version of edited/laid-out still picture and stores this additional edited/laid-out version of the still picture, e.g., in the disk memory 34 of the distribution node 17. After editing one or more still pictures, the patron user can enable one or more other users to access a specific edited/laid-out still picture. In addition, or in conjunction with this, the patron user can send copies of the still pictures, e.g., as postcards, to one or more specified recipients of the respective still pictures. After selecting the appropriate postcard or still picture (e.g., when reviewing it using the “view.asp” active server page 550), the patron user selects a “send” button. In response, an active server page “validate.asp” 540 is executed at the patron user node 5. This active server pages ensures that all of the required information was provided by the patron user for sending the postcard or still picture. If so, the “validate.asp” active server process 540 generates a unique URL specific to only the currently selected postcard or still picture. Uniqueness is guaranteed by subroutines embedded in the “validate.asp” active server process 540 which generate unique numbers for the postcard/still picture identifier and password, which may be embedded in the unique URL. The distribution node 17 then attaches this unique URL pointing to the edited/laid-out still picture. The distribution node then sends an email message via the Internet 3 to each node for which the patron user has specified an email address. The message includes the URL with the postcard/still picture identifier and password. An example of such a URL is in the form of:

http://www.picservice.com/viewasp?PicID=9897&Psw=8912

where “www.picservice.com” is the name of the company providing the still picture service, “PicID=9897” specifies a postcard/still picture identifier of 9897 and “Psw=8912” specifies a password of 8912.

Another user receiving such an email message can use the URL (postcard/still picture identifier and password) in the email message to send an instruction via the Internet 3 to the distribution node 17. The instruction causes the distribution node 17 to transfer the “View.asp” 550 active server process to the other user's node for execution and presentation. In response to the message, the distribution node 17 first confirms a valid access to a postcard/still picture. For example, the distribution node 17 can query the SQL database of still pictures using the postcard/still picture identifier and determine if the specified password is valid for this picture. If so, the distribution node 17 retrieves the postcard or still picture and transfers the retrieved postcard/still picture to the node of the requesting user via the Internet 3. The requesting user can then print out the still pictures and send an electronic “Thank You” card to the patron user. Illustratively, one or more sample “Thank You” cards are provided by the distribution node 17 to the user. The user can add text to such Thank You cards and can send them in emails via the Internet 3 directly to the patron user. Alternatively, the Thank You cards remain at the distribution node 17. Instead, the distribution node 17 sends an email message to the patron user node 5 with a URL and password which enable the patron user to retrieve the Thank You card from the distribution node 17.

Note that each time the patron user or another user accesses information from the distribution node 17, such as still pictures or Thank You cards, an e-commerce node 19 can also provide presentable hypertext links, solicitations or advertisements via the Internet 3 to the patron user node 5 or other user node 5. Such hypertext links, solicitations and/or advertisements are presented on the user node 5 of the patron or other user simultaneously as the pictures or Thank You cards. As described above, a presumption can often be made from the context by which a node accesses information as to what type of user is operating the node (i.e., a user, an invited guest, some other kind of user, etc.) or what type of action is performed (i.e., editing a picture, retrieving a picture, sending a Thank You, etc.). Such presumptions can be used to target advertisements, solicitations, hypertext links, etc. to a specific market segment.

The above description is intended to be merely illustrative of the invention. Those skilled in the art may devise numerous alternative embodiments without departing from the scope of the following claims.

The claimed invention is:

1. A method for facilitating capture and distribution of digital still pictures comprising the steps of:
(a) at a first node comprising a camera and a device capable of receiving user instructions, enabling a patron user to capture one or more of the images depicted by the camera as still pictures by providing the appropriate user instruction to the device capable of receiving user instructions,
(b) transferring one or more of the captured still pictures to a second node via a publicly accessible wide area network,
(c) transferring via the publicly accessible wide area network copies of one or more of the captured still pictures from the second node to a third node for display at the third node,
(d) receiving at the second node via the publicly accessible wide area network at least one instruction from the third node designating one or more versions of still pictures derived from the captured still pictures to be accessible by non-patron users, and
(e) at the second node, enabling transfer via the publicly accessible wide area network only copies of the one or more versions of the still pictures derived from the captured still pictures, but not the still pictures contained at the second node, to each node with permission to receive such versions of the still pictures other than a node validated by the second node as being operated by the patron user.

2. The method of claim 1 further comprising the steps of:
(f) transmitting an instruction from the third node to the second node via the wide area network indicating one or more email addresses of guest users to be permitted access to the one or more versions of the still pictures derived from the captured still pictures, and
(g) transmitting from the second node to one or more other nodes associated with the one or more email addresses a message pointing to the one or more versions of the still pictures for which access is permitted.

3. The method of claim 1 further comprising the step of:
(f) generating one of the versions of the still pictures from one or more captured still pictures by receiving from the third node at the second node via the publicly accessible wide area network one or more edit commands, the third node being capable of transferring an edit command which alters the displayed appearance of the one version of the still picture relative to the one or more capture still pictures from which it was derived.

4. The method of claim 3 further comprising the step of:
(g) transferring from the second node to the third node via the publicly accessible wide area network an executable software layout tool which can be used for generating the one version of the still pictures from the one or more captured still pictures.

5. The method of claim 4 wherein the third node executes a browser application which enables communication of presentable information communicated between the third node and other nodes via the publicly accessible wide area network and wherein the executable software layout tool is transferred to the third node while executing the browser application and executes at the third node in conjunction with the browser application.

6. The method of claim 1 further comprising the steps of:
(f) transferring, from an e-commerce node to a node requesting the transfer of one or more still pictures from the second node via the publicly accessible wide area network, one or more advertisements for presentation thereat.

7. The method of claim 6 further comprising the step of
(g) selecting a particular advertisement for transfer to each node targeted to a specific kind of user presumed to be operating the respective node to which the advertisement is to be transferred.

8. A system for facilitating capture and distribution of digital still pictures comprising the steps of:
a first node comprising a camera, and a device capable of receiving user instructions, for enabling a patron user to capture one or more images depicted by the camera as still pictures by providing the appropriate user instruction to the device capable of receiving user instructions, and
a second node for receiving from the first node via a publicly accessible wide area network the pictures captured by the first node, for transferring via the publicly accessible wide area network copies of one or more of the capture still pictures to a third node for display at the third node, for receiving at the second node via the publicly accessible wide area network at least one instruction from the third node designating one or more versions of still pictures derived from the captured still pictures to be accessible by non-patron users, and for enabling transfer via the publicly accessible wide area network only copies of the one or more versions of the still pictures derived from the captured still pictures, but not other still pictures contained at the second node, to each node with permission to receive such versions of the still pictures other than a node validated by the second node as being operated by the patron user.

9. The system of claim 8 wherein the second node is also for receiving from the third node an instruction transferred via the wide area network indicating one or more email addresses of guest users permitted to access the one or more versions of the still pictures derived from the captured still pictures, and for transmitting from the second node to one or more other nodes associated with the one or more email addresses a message pointing to the one or more versions of the still pictures for which access is permitted.

10. The system of claim 8 wherein one of the versions of the still pictures is generated from one or more captured still pictures by receiving at the second node via the publicly accessible wide area network one or more edit commands from the third node, the third node being capable of transferring an edit command which alters the displayed appearance of the one version of the still picture relative to the one or more capture still pictures from which it was derived.

11. The system of claim 10 wherein the second node is also for transferring to the third node via the publicly accessible wide area network an executable software layout tool which can be used for generating the one version of the still pictures from the one or more captured still pictures.

12. The system of claim 11, wherein the third node executes a browser application which enables communication of presentable information communicated between the third node and other nodes via the publicly accessible wide area network and wherein the executable software layout tool is transferred to the third node while executing the browser application and executes at the third node in conjunction with the browser application.

13. The system of claim 8 further comprisingL
an e-commerce node for transferring to a node requesting the transfer of one or more still pictures from the second node via the publicly accessible wide area network, one or more advertisements for presentation thereat.

14. The system of claim 13 wherein the e-commerce node is also for selecting a particular advertisement for transfer to each node targeted to a specific kind of user presumed to be operating the respective node to which the advertisement is to be transferred.
